(19) United States
(12) Patent Application Publication
(10) Pub. No.: US 2026/0061819 A1
(43) Pub. Date: Mar. 5, 2026

(54) PICKUP TRUCK

(71) Applicant: TOYOTA JIDOSHA KABUSHIKI KAISHA, Toyota-shi Aichi-ken (JP)

(72) Inventors: Michio YOSHIDA, Susono-shi (JP); Tomoaki YANAGIDA, Susono-shi (JP); Taku SEGAWA, Numazu-shi (JP); Yoshiteru INAMOTO, Toyota-shi (JP); Takumi JINMON, Ann Arbor, MI (US); Taesoo KIM, Ann Arbor, MI (US); Jason CREMER, Stockbridge, MI (US); Juan VELASCO, Ypsilanti, MI (US); Takehito YODA, Novi, MI (US); David NAKAYAMA, Canton, MI (US); Ryan HARRIS, Saline, MI (US)

(73) Assignee: TOYOTA JIDOSHA KABUSHIKI KAISHA, Toyota-shi Aichi-ken (JP)

(21) Appl. No.: 19/310,006

(22) Filed: Aug. 26, 2025

(30) Foreign Application Priority Data
Aug. 29, 2024 (JP) 2024-147280

(51) Int. Cl. B60K 1/04

(52) U.S. Cl. CPC B60K 1/04; B60K 2001/0416; B60K 2001/0433

(57) ABSTRACT

A pick-up truck type plug-in hybrid electric vehicle includes, from the front, an engine compartment section having an engine compartment in which an engine is arranged longitudinally, a cabin section having a passenger compartment, and a cargo section having a truck bed that opens upward. A front-row seat and a rear-row seat that is disposed rearward of the front-row seat are installed in the passenger compartment. The pickup truck further includes a first battery and a second battery. The first battery is installed in a region in the cabin section that is below the rear-row seat. The second battery is installed in the cargo section. The first battery and the second battery are power sources for a motor.

### CROSS-REFERENCE TO RELATED APPLICATIONS

This application is based upon and claims the benefit of priority from JP2024-147280A, filed on Aug. 29, 2024, the entire contents of which are incorporated herein by reference.

### BACKGROUND

### 1. Field

The present disclosure relates to a pickup truck configured as a plug-in hybrid electric vehicle.

### 2. Description of Related Art

Japanese Laid-Open Patent Publication No. 2022-085506 discloses a hybrid electric vehicle that includes a longitudinally mounted engine and a battery disposed in an area surrounding the propeller shaft located beneath the vehicle floor.

A plug-in hybrid electric vehicle (hereinafter referred to as a PHEV) is externally rechargeable and includes a large-capacity battery in addition to two drive sources, namely, an engine and a motor. One known vehicle type is a pickup truck. A pickup truck includes a truck bed, which is rearward of the cabin and opens upward. Many pickup trucks include a body having a frame structure. A variety of components, including a transmission, a propeller shaft, an exhaust pipe, and a fuel tank, are disposed beneath the floor of a pickup truck. Therefore, when converting a pickup truck into a PHEV, it may not be possible to allocate space beneath the floor to accommodate a battery.

### SUMMARY

This Summary is provided to introduce a selection of concepts in a simplified form that are further described below in the Detailed Description. This Summary is not intended to identify key features of the claimed subject matter, nor is it intended to be used as an aid in determining the scope of the claimed subject matter.

In one general aspect, a pickup truck configured as a plug-in hybrid electric vehicle includes a fuel tank, an engine, a motor, a transmission, a propeller shaft connected to the engine via the motor and the transmission and configured to transmit rotational driving force of the engine and the motor to a rear wheel, an exhaust pipe configured to guide exhaust gas of the engine rearward in the vehicle, a cabin section provided with a passenger compartment, an engine compartment section forward of the cabin section, a cargo section rearward of the cabin section, and a frame including left and right side members that extend in a vehicle longitudinal direction through a region in the cabin section that is below the passenger compartment. The engine compartment section includes an engine compartment in which the engine is arranged longitudinally. The cargo section includes a truck bed that opens upward. The propeller shaft and the exhaust pipe extend in the vehicle longitudinal direction through the region in the cabin section that is below the passenger compartment. A front-row seat and a rear-row seat that is disposed rearward of the front-row seat are installed in the passenger compartment. The pickup truck further includes a first battery installed in a region in the cabin section that is below the rear-row seat, and a second battery installed in the cargo section. The first battery and the second battery are power sources for the motor.

Other features and aspects will be apparent from the following detailed description, the drawings, and the claims.

### BRIEF DESCRIPTION OF THE DRAWINGS

FIG. 1 is a side view illustrating the arrangement of components in a pickup truck according to a first embodiment.

FIG. 2 is a top view illustrating the arrangement of components such as a drivetrain, a frame, an exhaust pipe, and a fuel tank of the pickup truck shown in FIG. 1.

FIG. 3 is a side view illustrating the arrangement of components such as a battery in the pickup truck shown in FIG. 1.

FIG. 4 is a top view illustrating the arrangement of components such as the battery in the pickup truck shown in FIG. 1.

FIG. 5 is a side view illustrating the arrangement of components such as a battery in a pickup truck according to a second embodiment.

FIG. 6 is a top view illustrating the arrangement of components such as the battery in the pickup truck shown in FIG. 5.

FIG. 7 is a side view illustrating the arrangement of components such as a battery in a pickup truck according to a third embodiment.

FIG. 8 is a top view illustrating the arrangement of components such as the battery in the pickup truck shown in FIG. 7.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

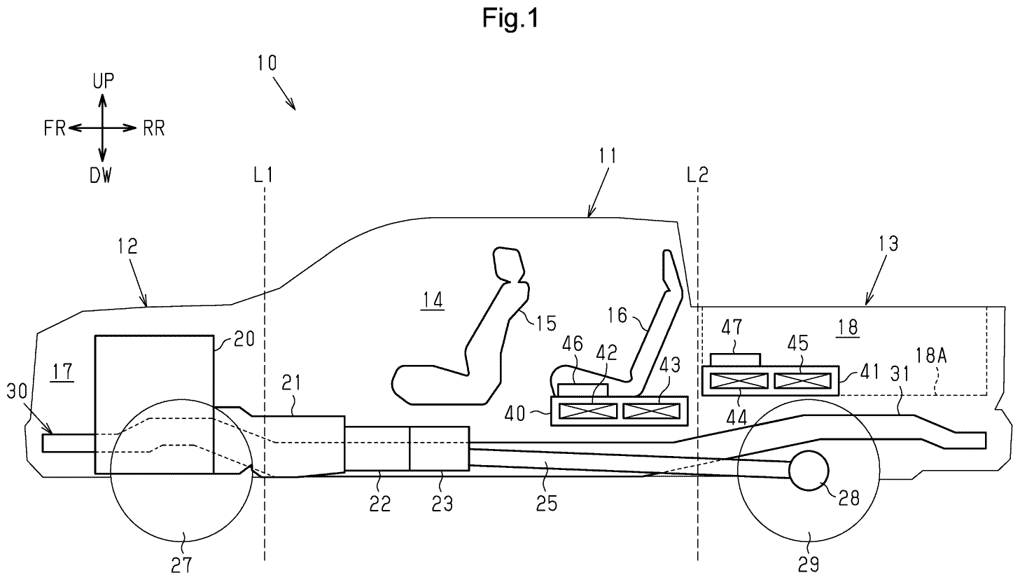

A pickup truck 10 according to a first embodiment will now be described with reference to FIGS. 1 to 4. Arrows shown in FIGS. 1 to 8 indicate directions in relation to the pickup truck 10. Specifically, FR indicates the forward direction, RR indicates the rearward direction, UP indicates the upward direction, DW indicates the downward direction, LF indicates the leftward direction, and RF indicates the rightward direction. The pickup truck 10 of the present embodiment is configured as a PHEV.

As shown in FIG. 1, the pickup truck 10 includes three sections, i.e., a cabin section 11, an engine compartment section 12 forward of the cabin section 11, and a cargo section 13 rearward of the cabin section 11. The cabin section 11 is provided with a passenger compartment 14, which accommodates occupants. Front-row seats 15 and a rear-row seat 16, which is positioned rearward of the front-row seats 15, are installed in the passenger compartment 14. The engine compartment section 12 includes an engine compartment 17 in which the engine 20 is arranged longitudinally. An engine 20 having a V-type cylinder arrangement is mounted on the pickup truck 10 of the present embodiment. The cargo section 13 includes a truck bed 18 that opens upward. In the drawings, the boundary between the cabin section 11 and the engine compartment section 12 is indicated by dotted line L1. The boundary between the cabin section 11 and the cargo section 13 is indicated by dotted line L2.

### Configuration of the Drivetrain of the Pickup Truck

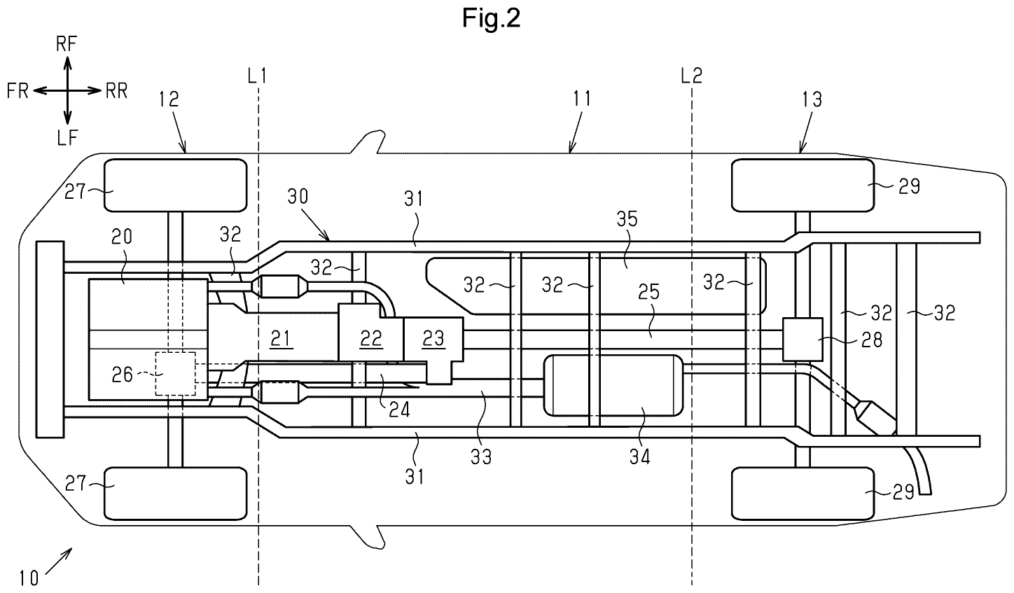

Next, the configuration of the drive system of the pickup truck 10 will be described with reference to FIG. 2. The drivetrain of the pickup truck 10 includes the engine 20, a transmission 21, a motor 22, and a transfer case 23. The motor 22 is configured both to generate rotational driving force for driving the pickup truck 10 in response to supplied electric power and to generate electric power based on the rotation of the engine 20 or the wheels. The drivetrain of the pickup truck 10 includes propeller shafts 24 and 25 for the front and rear wheels. The propeller shafts 24 and 25 are each connected to the engine 20 via the transfer case 23, the motor 22, and the transmission 21. The propeller shaft 24 for the front wheels is connected to right and left front wheels 27 via a differential 26. The propeller shaft 25 for the rear wheels is connected to right and left rear wheels 29 via a differential 28. The propeller shaft 25 for the rear wheels is configured to guide rotational driving force of the engine 20 and the motor 22 to the rear wheels 29.

### Configuration of Underfloor Structure of the Pickup Truck

The configuration of the underfloor structure of the pickup truck 10 will now be described with reference to FIG. 2. The space under the floor of the pickup truck 10 refers to regions below floor panels 14A, 18A of the passenger compartment 14 and the truck bed 18.

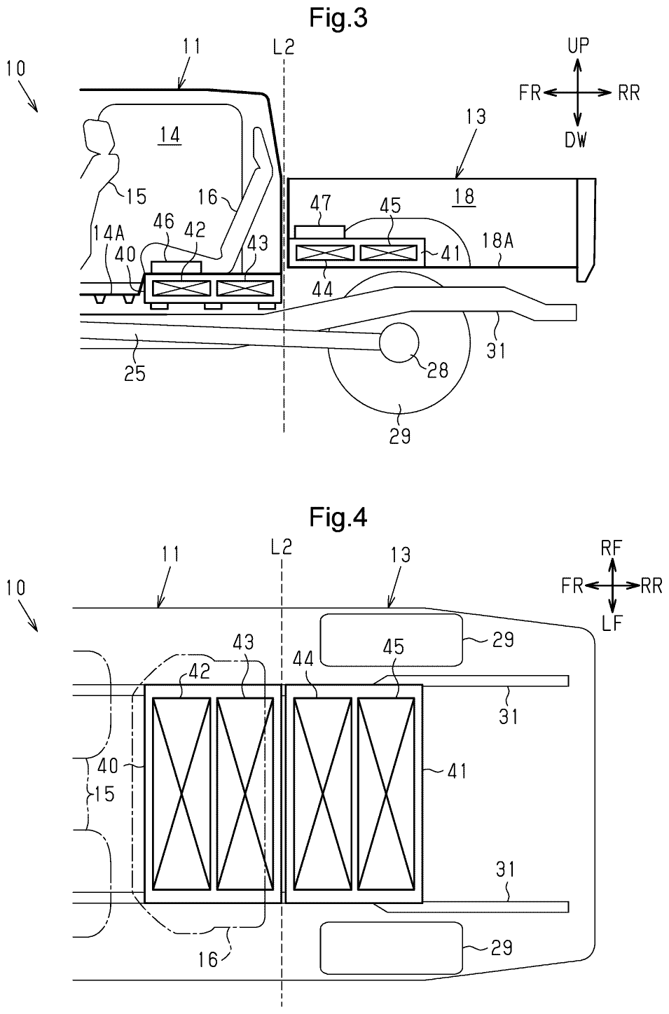

A frame 30 is provided under the floor of the passenger compartment 14 and the truck bed 18 of the pickup truck 10. The frame 30 of the pickup truck 10 of the present embodiment is a ladder-type frame having left and right side members 31 and multiple cross members 32 each connecting the side members 31 to each other. The left and right side members 31 are each disposed so as to extend in the vehicle longitudinal direction through a region in the cabin section 11 that is below the passenger compartment 14. As shown in FIG. 3, the propeller shaft 25 for the rear wheels extends in the vehicle longitudinal direction through the region in the cabin section 11 that is below the passenger compartment 14.

An exhaust pipe 33 that guides exhaust gas of the engine 20 rearward is disposed under the floor of the pickup truck 10. The exhaust pipe 33 extends in the vehicle longitudinal direction through the region in the cabin section 11 that is below the passenger compartment 14. A muffler 34 is installed at an intermediate portion of the exhaust pipe 33. The muffler 34 is disposed in the region in the cabin section 11 that is below the passenger compartment 14. A fuel tank 35 for storing fuel for the engine 20 is installed under the floor of the pickup truck 10. The propeller shaft 25 for the rear wheels is disposed in a region between the exhaust pipe 33 and the fuel tank 35 in the vehicle width direction.

### Arrangement of Batteries

Next, the arrangement of batteries of the pickup truck 10 will be described with reference to FIGS. 3 and 4. The pickup truck 10 is provided with two batteries, i.e., a first battery 40 and a second battery 41. The first battery 40 and the second battery 41 are power sources for the motor 22. The first battery 40 and the second battery 41 are electrically connected to each other by a harness, a bus bar, or the like.

The first battery 40 is disposed in a region in the cabin section 11 that is below the rear-row seat 16. In the present embodiment, the first battery 40 is disposed outside the passenger compartment 14, and specifically, below the floor panel 14A of the passenger compartment 14. In the present embodiment, the first battery 40 is arranged such that the front end thereof is located rearward of the front end of the rear-row seat 16.

The second battery 41 is installed in the cargo section 13. In the present embodiment, the second battery 41 is installed in a region in the cargo section 13 that is adjacent to the cabin section 11; specifically, at the front end of the cargo section 13. In the present embodiment, the second battery 41 is installed on the floor panel 18A of the truck bed 18. In FIG. 3, the second battery 41 is installed on the floor panel 18A in an exposed state. However, the second battery 41 may be installed in a covered state.

Each of the first battery 40 and the second battery 41 has two modules 42, 43 or 44, 45 arranged in the vehicle longitudinal direction. Each of the modules 42 to 45 is a battery pack composed of multiple cells (unit batteries). In the present embodiment, each of the modules 42 to 45 is formed by multiple cells arranged in the vehicle width direction. In the pickup truck 10, each of the modules 42 to 45 includes cells that conform to a common standard. Each of the modules 42 to 45 includes the same number of cells. As described above, the first battery 40 and the second battery 41 includes the modules 42 to 45 having the same structure.

The first battery 40 and the second battery 41 include high-voltage electrical units 46 and 47, respectively. The high-voltage electrical unit 46 is installed on the first battery 40 and is located above the modules 42 and 43. The high-voltage electrical unit 47 is installed on the second battery 41 and is located above the modules 44 and 45. The high-voltage electrical units 46, 47 are vehicle on-board electric devices configured to perform power conversion or power distribution. Examples of the high-voltage electrical units 46, 47 include a power control unit, a charging control unit, a step-down unit, and a junction box. A power control unit is an electrical unit that performs power control of the motor 22. A charging control unit is an electrical unit configured to control charging of the first battery 40 or the second battery 41. A step-down unit is an electrical unit configured to convert high-voltage power output from the first battery 40 or the second battery 41 into low-voltage power to be supplied to vehicle on-board electric devices other than the motor 22. A junction box is an electrical unit having a function as a distribution board. The high-voltage electrical units 46, 47 may be electrical units of the same type or may be electrical units of different types. The high-voltage electrical units 46, 47 may be configured to have functions of multiple electrical units.

### Operation of the First Embodiment

In addition to the frame 30, components such as the propeller shaft 25, the exhaust pipe 33, and the fuel tank 35 are installed under the floor of the pickup truck 10, which is configured as a PHEV. Therefore, it is difficult to allocate sufficient mounting space beneath the floor of the pickup truck 10 for the batteries, which supply power to the motor 22.

The pickup truck 10 of the present embodiment includes the first battery 40 and the second battery 41, which are power sources for the motor 22. The first battery 40 is installed in a region in the cabin section 11 that is below the rear-row seat 16. The second battery 41 is installed in the cargo section 13. By providing multiple batteries and installing them at separate locations, it is possible to accommodate a battery system with a large total capacity, even in the pickup truck 10 configured as a PHEV.

### Aspects of the First Embodiment

The pickup truck 10 of the present embodiment, configured as described above, provides the following aspects.
(1) The batteries are separately disposed in the region in the cabin section 11 that is below the rear-row seat 16 and in the cargo section 13. This configuration readily allows a battery system with a large total capacity to be installed in the pickup truck 10 configured as a PHEV.
(2) The front end of the first battery 40 is located rearward of the front end of the rear-row seat 16. As a result, installation of the first battery 40 does not significantly reduce the foot space available to an occupant seated in the rear-row seat 16.
(3) The second battery 41 is disposed in the region in the cargo section 13 that is adjacent to the cabin section 11. The distance between the second battery 41 and the first battery 40, which is installed below the rear-row seat 16 is relatively short. This configuration facilitates routing of a harness or the like for electrically connecting the first battery 40 to the second battery 41.
(4) The first battery 40 and the second battery 41 include the common modules 42 to 45. As a result, many of the components used in the first battery 40 and the second battery 41 are of the same type.
(5) Each of the first battery 40 and the second battery 41 has two modules 42, 43 or 44, 45 arranged in the vehicle longitudinal direction. Therefore, the heights of the first battery 40 and the second battery 41 are lower than in a case in which the modules 42 to 45 are arranged in the vehicle height direction. As a result, the first battery 40 and the second battery 41 can be more readily installed in limited spaces such as below the rear-row seat 16 or within the cargo section 13. In particular, by reducing the height of the second battery 41, it is possible to minimize the reduction of available cargo space in the truck bed 18 resulting from installation of the second battery 41.
(6) The first battery 40 is installed outside the passenger compartment 14. This configuration provides greater isolation between the occupants and the first battery 40 than a configuration in which the first battery 40 is installed inside the passenger compartment 14.

### Second Embodiment

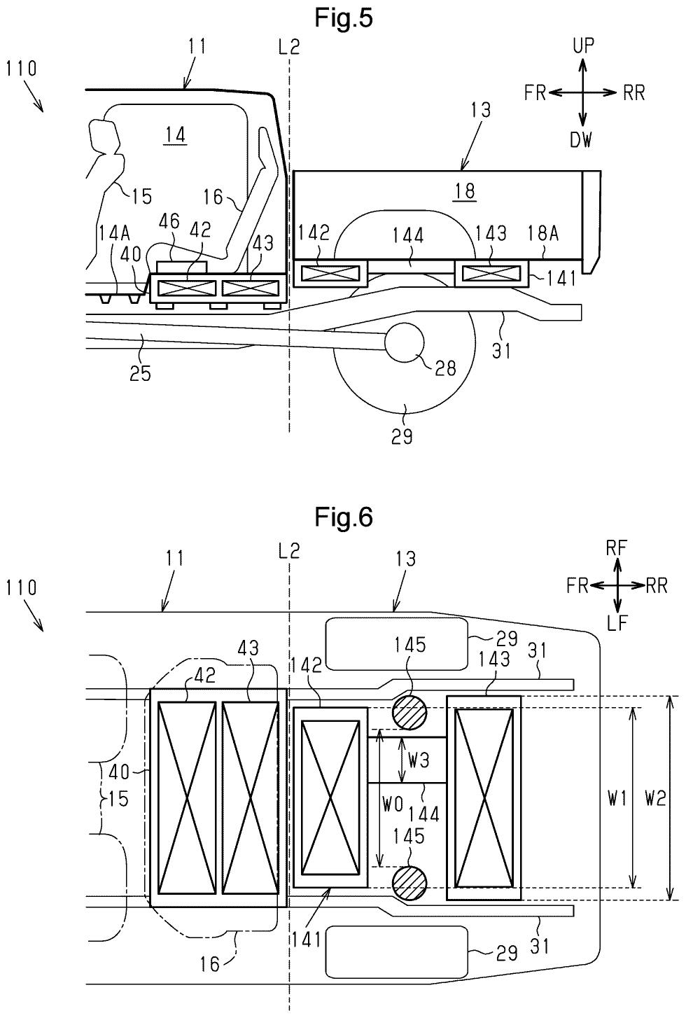

A pickup truck 110 according to a second embodiment will now be described with reference to FIGS. 5 and 6. In the present embodiment, like or the same reference numerals are given to those components that are like or the same as the corresponding components of the above-described embodiments, and the detailed description will be omitted. The present embodiment is different from the first embodiment in the configuration and arrangement of a second battery 141.

As shown in FIGS. 5 and 6, in the pickup truck 110 of the present embodiment, the first battery 40 is also disposed in a region in the cabin section 11 that is below the rear-row seat 16, and the second battery 141 is disposed in the cargo section 13. In the present embodiment, the second battery 141 is disposed below the floor panel 18A of the truck bed 18 and above the side members 31. In the present embodiment, the second battery 141 is disposed such that the bottom surface thereof is located above the bottom surface of the first battery 40 and below the upper surface of the first battery 40. That is, the first battery 40 and the second battery 141 at least partially overlap each other in the vehicle height direction.

As shown in FIG. 6, right and left struts 145, which are components of the suspensions of the rear wheels 29, are disposed inward of the side members 31 under the floor of the truck bed 18. Therefore, when the second battery 141 is disposed under the floor of the truck bed 18, it is necessary to avoid interference with the struts 145.

In the present embodiment, the second battery 141 includes a first module 142, a second module 143, and a high-voltage electrical unit 144. The first module 142, which is a front portion, is installed at a front end portion of the cargo section 13; specifically, a portion of the cargo section 13 adjacent to the cabin section 11. The second module 143, which is a rear portion, is spaced apart from and rearward of the first module 142. The high-voltage electrical unit 144, which is a central portion, is installed between the first module 142 and the second module 143 in the vehicle longitudinal direction, and is connected to each of the first module 142 and the second module 143. The high-voltage electrical unit 144 is located between the left and right struts 145.

A dimension W1 of the first module 142 in the vehicle width direction and a dimension W2 of the second module 143 in the vehicle width direction are greater than a distance W0 between the left and right struts 145. In contrast, a dimension W3 of the high-voltage electrical unit 144 in the vehicle width direction is less than the distance W0 between the left and right struts 145. The overall shape of the second battery 141 is an H-shape in which the length of the central portion in the vehicle width direction is less than the lengths of the front portion and the rear portion in the vehicle width direction.

### Aspects of the Second Embodiment

The pickup truck 110 of the present embodiment configured as described above provides the following aspects in addition to the aspects described in items (1) to (3) and (6) above.
(7) The shape of the second battery 141 is an H-shape in which the length of the central portion in the vehicle width direction is less than the lengths of the front portion and the rear portion in the vehicle width direction. This configuration facilitates the installation of the second battery 141 under the truck bed 18 while avoiding interference with the struts 145.
(8) The second battery 141 includes two modules, namely the first module 142 and the second module 143, and the high-voltage electrical unit 144. The high-voltage electrical unit 144 is located rearward of the first module 142 and forward of the second module 143. This arrangement enables the second battery 141 to adopt the H-shaped configuration described above. Since the first module 142, the second module 143, and the high-voltage electrical unit 144 are arranged in the vehicle longitudinal direction, the height of the second battery 141 is relatively low. As a result, the second battery 141 can be installed in the limited space between the floor panel 18A of the truck bed 18 and the side members 31.
(9) The bottom surface of the second battery 141 is located above the bottom surface of the first battery 40 and below the upper surface of the first battery 40. This configuration facilitates routing of a harness or the like for electrically connecting the first battery 40 to the second battery 141.

### Third Embodiment

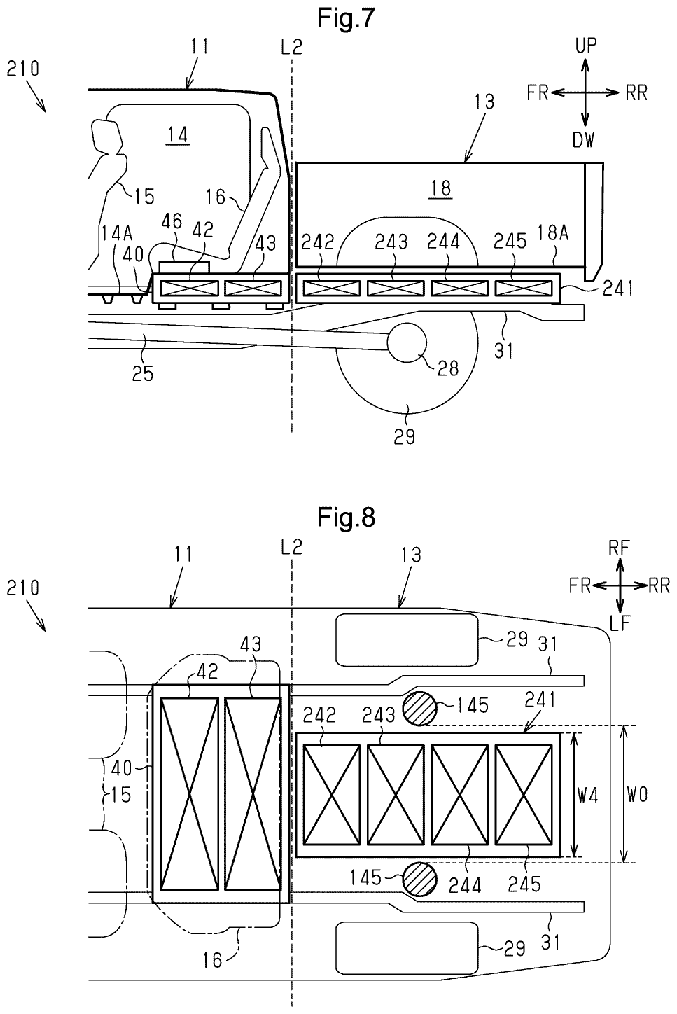

A pickup truck 210 according to a third embodiment will now be described with reference to FIGS. 7 and 8. In the present embodiment, like or the same reference numerals are given to those components that are like or the same as the corresponding components of the above-described embodiments, and the detailed description will be omitted. The present embodiment is different from the above-described embodiments in the configuration and arrangement of a second battery 241.

As shown in FIGS. 7 and 8, in the pickup truck 210 of the present embodiment, the first battery 40 is also disposed in a region in the cabin section 11 that is below the rear-row seat 16, and the second battery 241 is disposed in the cargo section 13. In the present embodiment, the second battery 241 is disposed below the floor panel 18A of the truck bed 18 and above the side members 31. In the present embodiment, the second battery 241 is disposed such that the position thereof in the vehicle height direction is the same as the position of the first battery 40 in the vehicle height direction.

The second battery 241 is formed by four modules 242 to 245 arranged in the vehicle longitudinal direction. Each of the modules 242 to 245 is formed by multiple cells arranged in the vehicle width direction. The total number of cells included in the second battery 241 is approximately equal to the total number of cells included in the first battery 40 formed by the two modules 42 and 43. Accordingly, the second battery 241 has a comparable capacity to the first battery 40 while achieving a smaller dimension W4 in the vehicle width direction than that of the first battery 40.

The pickup truck 210 of the present embodiment configured as described above provides the following aspects in addition to the aspects described in items (1) to (3), (6), and (9) above.
(10) The dimension W4 of the second battery 241 in the vehicle width direction is less than the distance between the left and right struts 145 of the rear suspensions of the left and right rear wheels 29. This configuration facilitates the installation of the second battery 241 under the truck bed 18 while avoiding interference with the struts 145.
(11) The modules 242 to 245 forming the second battery 241 are arranged in the vehicle longitudinal direction. As a result, the height of the second battery 241 is relatively low, facilitating installation of the second battery 241 in the narrow space between the floor panel 18A of the truck bed 18 and the side members 31.

### Other Embodiments

The above-described embodiments may be modified as follows. The above-described embodiments and the following modifications can be combined if the combined modifications remain technically consistent with each other.

### Arrangement of the High-Voltage Electrical Unit

The high-voltage electrical units 46, 47, and 144 may be included in only one of the first battery 40 or the second battery 41, 141, or 241.

The high-voltage electrical units 46, 47, and 144 may be formed as separate components from the first battery 40 and the second batteries 41, 141, and 241.

### Configuration of the Batteries

The number or arrangement of the modules of the first battery 40 and the second batteries 41, 141, and 241 may be changed. For example, the modules may be arranged in the vehicle width direction or the vehicle height direction.

The first battery 40 may be disposed inside the passenger compartment 14. Specifically, the first battery 40 may be disposed in a region in the cabin section 11 that is below the rear-row seat 16 and above the floor panel 14A of the passenger compartment 14.

In the pickup truck 110 of the second embodiment, the H-shaped configuration of the second battery 141 is achieved by positioning the high-voltage electrical unit 144 at the center of the second battery 141. However, other configurations may also be used to achieve the H-shaped configuration of the second battery 141. For example, modules including multiple cells arranged in the vehicle width direction may be placed at the front and rear portions of the second battery 141, while a module including multiple cells arranged in the vehicle longitudinal direction may be placed at the center portion of the second battery 141 to form an H-shaped configuration of the second battery 141.

### Other Modifications

As the engine 20, an engine having a cylinder arrangement other than the V type may be employed. The engine 20 may be transversely mounted within the engine compartment 17.

The arrangement of components such as the propeller shaft 25, the exhaust pipe 33, the muffler 34, and the fuel tank 35 under the floor of the pickup truck 10, 110, 210 may be changed. For example, the propeller shaft 25 may be disposed in a region other than the space between the exhaust pipe 33 and the fuel tank 35 in the vehicle width direction.

The configuration of the drivetrain of the pickup truck 10, 110, 210 can be changed. For example, the drivetrain may be configured to drive the front wheels 27 and the rear wheels 29 via separate, independent drive systems. Alternatively, the drivetrain may be configured such that the pickup truck 10, 110, 210 is a front-wheel drive vehicle.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A pickup truck configured as a plug-in hybrid electric vehicle, comprising:
a fuel tank;
an engine;
a motor;
a transmission;
a propeller shaft connected to the engine via the motor and the transmission and configured to transmit rotational driving force of the engine and the motor to a rear wheel;
an exhaust pipe configured to guide exhaust gas of the engine rearward in the vehicle;
a cabin section provided with a passenger compartment;
an engine compartment section forward of the cabin section;
a cargo section rearward of the cabin section; and
a frame including left and right side members that extend in a vehicle longitudinal direction through a region in the cabin section that is below the passenger compartment, wherein
the engine compartment section includes an engine compartment in which the engine is arranged longitudinally,
the cargo section includes a truck bed that opens upward,
the propeller shaft and the exhaust pipe extend in the vehicle longitudinal direction through the region in the cabin section that is below the passenger compartment,
a front-row seat and a rear-row seat that is disposed rearward of the front-row seat are installed in the passenger compartment,
the pickup truck further comprises:
a first battery installed in a region in the cabin section that is below the rear-row seat; and
a second battery installed in the cargo section, and
the first battery and the second battery are power sources for the motor.

2. The pickup truck according to claim 1, wherein a front end of the first battery is located rearward of a front end of the rear-row seat.

3. The pickup truck according to claim 1, wherein the second battery is disposed in a region in the cargo section that is adjacent to the cabin section.

4. The pickup truck according to claim 1, wherein a bottom surface of the second battery is located above a bottom surface of the first battery and below an upper surface of the first battery.

5. The pickup truck according to claim 1, wherein the first battery and the second battery are formed by modules having a same structure.

6. The pickup truck according to claim 1, wherein each of the first battery and the second battery includes two modules arranged in the vehicle longitudinal direction.

7. The pickup truck according to claim 1, wherein
the second battery includes:
a front portion;
a rear portion spaced apart from and disposed rearward of the front portion; and
a central portion disposed between the front portion and the rear portion, and
the second battery has an H-shape, and a dimension of the central portion in a vehicle width direction is less than dimensions of the front portion and the rear portion in the vehicle width direction.

8. The pickup truck according to claim 1, wherein
the second battery includes:
two modules that are a first module and a second module; and
a high-voltage electrical unit, and
the high-voltage electrical unit is located rearward of the first module and forward of the second module.

9. The pickup truck according to claim 1, wherein
the rear wheel is one of left and right rear wheels, and
a dimension of the second battery in a vehicle width direction is less than a distance between struts of suspensions of the left and right rear wheels.

10. The pickup truck according to claim 1, wherein the first battery is installed outside the passenger compartment.
